(19) United States
(12) Patent Application Publication
(10) Pub. No.: US 2008/0193607 A1
(43) Pub. Date: Aug. 14, 2008

(54) LAYERED PET TREAT AND PROCESS FOR MAKING SAME

(76) Inventors: Jacob Tepper, Boca Raton, FL (US); Steven Mendal, New York, NY (US); Dean Triandafellos, Freehold, NJ (US)

Correspondence Address: GREENBERG TRAURIG, LLP, 200 PARK AVE., P.O. BOX 677, FLORHAM PARK, NJ, 07932, US

(21) Appl. No.: 11/870,087

(22) Filed: Oct. 10, 2007

Related U.S. Application Data
(60) Provisional application No. 60/850,570, filed on Oct. 10, 2006.

(51) Int. Cl. A23K 1/10; A01K 15/02

(52) U.S. Cl. 426/92; 426/272; 426/237

(57) ABSTRACT

A pet treat includes a top layer of meat and a bottom layer of rawhide that has been flavored with meat. An intermediate layer of glutin formed during the manufacturing process affixes the top layer of meat to the bottom layer of rawhide. During the dehydration step, the rawhide and the glutin are flavored by liquid seeped from the meat.

### CROSS-REFERENCE TO RELATED APPLICATION

This application claims the benefit of U.S. Provisional Patent Application No. 60/850,570 filed Oct. 10, 2006, the disclosure of which is incorporated herein by reference in its entirety.

### FIELD OF THE INVENTION

The present invention relates to pet treats and to a process for making same.

### BACKGROUND OF THE INVENTION

It is well known that chewing provides numerous health benefits to pets. For example, chewing allows pets to exercise their jaws. Chewing also promotes teeth cleaning, thereby reducing plaque and tartar buildup.

In an effort to realize the foregoing benefits, pet treats have been developed to promote chewing over an extended period of time. These pet treats are commonly made with pure rawhide. However, such rawhide pet treats are typically dry and lack substantial flavor, and are therefore unappealing to pets.

Some rawhide pet treats are coated with flavorings in an attempt to improve their palatability. Because the coatings are only applied to the outer layer of such rawhide pet treats, the remaining (i.e., uncoated) portions of these treats still lack substantial flavor. As a result, pets rapidly consume the coated outer layer, and then do not chew on the remaining portions of the treat. Accordingly, pets tend to chew on rawhide pet treats for only a relatively short period of time. In addition, the coated rawhide pet treat can stain carpets and other items inside a house. Thus, coated rawhide pet treats are suitable only for outdoor consumption.

Another type of pet treat is made with pure meat. While these pet treats may be palatable, they are rapidly consumed and therefore do not promote chewing for an extended period of time.

### SUMMARY OF THE INVENTION

The present invention overcomes the disadvantages and shortcomings of the prior art discussed above by providing a new and improved pet treat. More particularly, the pet treat includes a top layer of meat, which is highly palatable. The pet treat also includes a bottom layer of rawhide that has been flavored with meat, thereby improving the palatability of the rawhide. An intermediate layer of glutin is formed during the manufacturing process and affixes the top layer of meat to the bottom layer of rawhide. Thus, the pet treat provides two separate treats, which can be consumed indoors or outdoors.

A new and improved process for preparing the pet treat is also provided. During a dehydration step that is performed for a long period of time, the rawhide and the glutin are flavored by liquid seeped from the meat.

### BRIEF DESCRIPTION OF THE DRAWINGS

For a more complete understanding of the present invention, reference is made to the following detailed description of an exemplary embodiment of the present invention considered in conjunction with the accompanying drawings, in which:

FIG. 1 is a perspective view of a pet treat which has been prepared in accordance with one exemplary embodiment of the present invention;

FIG. 2 is a cross-sectional view, taken along section line 2-2 and looking in the direction of the arrows, of the pet treat shown in FIG. 1; and

FIG. 3 is a cross-sectional view, taken along section line 3-3 and looking in the direction of the arrows, of the pet treat shown in FIG. 1.

### DETAILED DESCRIPTION OF THE INVENTION

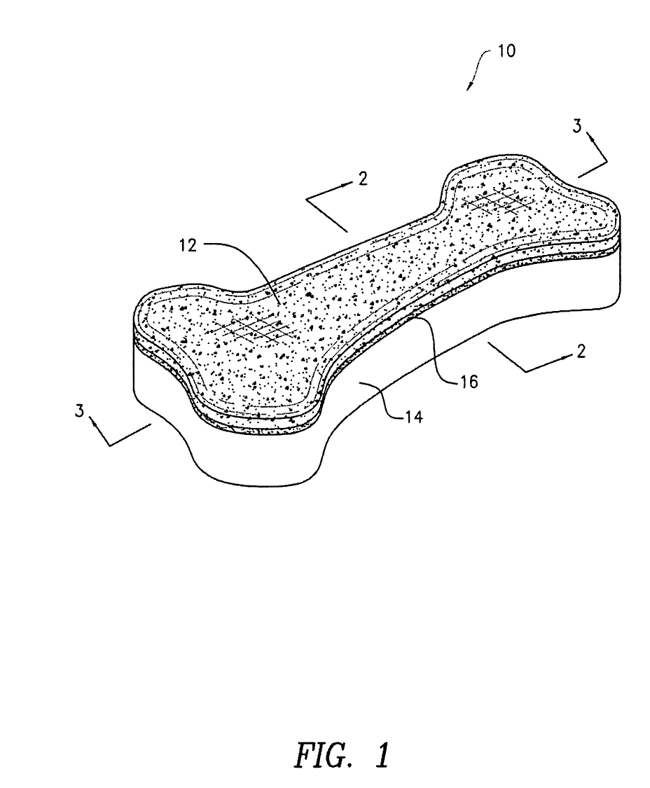

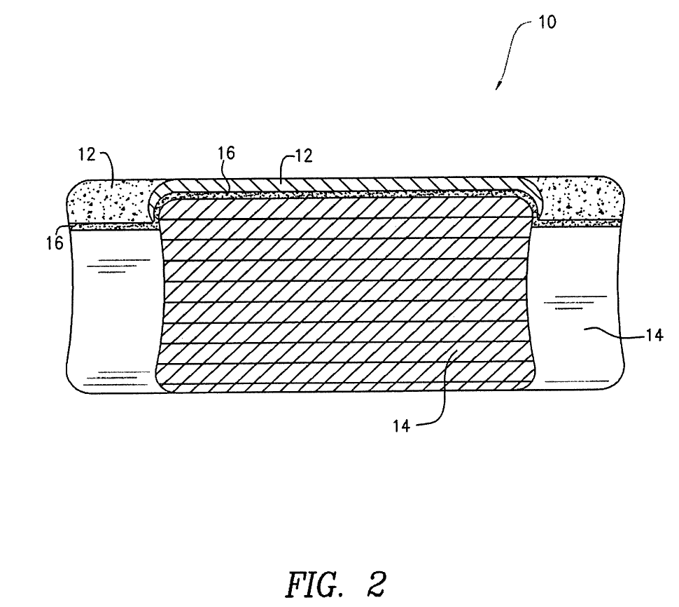

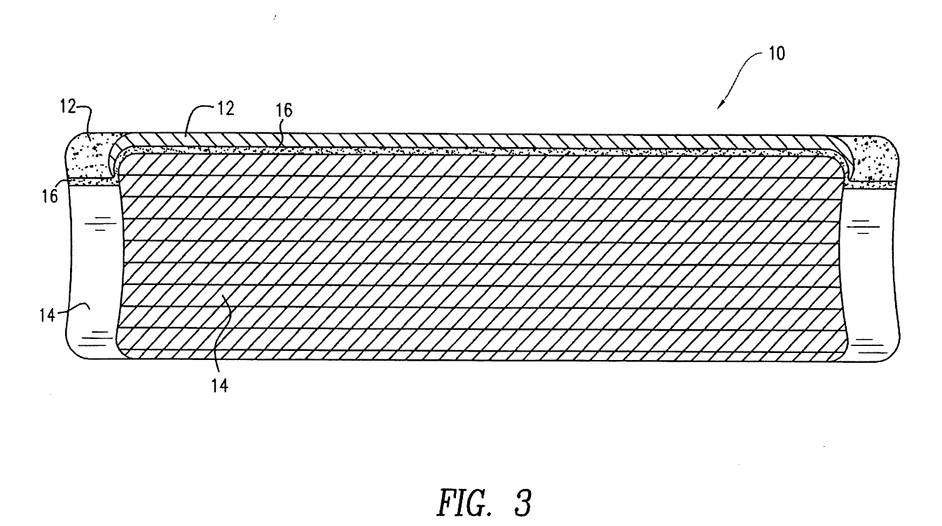

FIGS. 1-3 illustrate a pet treat 10 including a top layer 12 made of meat and a bottom layer 14 made of rawhide that has been flavored with meat during the manufacturing process. As used hereinafter, the term “meat” could include, but is not limited to, chicken, beef, pork, lamb, turkey, fish, any other animal meat, or a combination of animal meats.

With continued reference to FIGS. 1-3, the pet treat 10 also includes an intermediate layer 16 made of glutin formed between the top layer 12 of meat and the bottom layer 14 of flavored rawhide. More particularly, the intermediate layer 16 of glutin is formed from rawhide and flavored with meat during the manufacturing process, as will be described in further detail hereinafter. The intermediate layer 16 of flavored glutin serves to affix the top layer 12 of meat to the bottom layer 14 of flavored rawhide.

The pet treat 10 has a bone-shape, but it is understood that the pet treat 10 can have other shapes, such as a heart-shape, cubic, a rectangular prism, polyhedron, etc. The top layer 12 of meat has a general shape substantially matching that of the bottom layer 14 of flavored rawhide.

The process for preparing the pet treat 10 involves a first step of allowing frozen meat to thaw naturally. The thawed meat is then cleaned out thoroughly by performing two separate steps. More particularly, the first cleaning step involves washing the meat with a disinfecting agent, such as potassium or sodium hypochlorite water, in order to reduce the microbial content of the meat. An amount of 100 ppm potassium or sodium hypochlorite water can be used. The second cleaning step involves washing the meat with pure water.

The next step involves mixing the meat with the following additives: 1% to 1.2% of sugar, 0.6% to 1% of salt, 0.1% to 0.15% of potassium sorbate, and 0.04% to 0.1% of araboascorbic acid. It will be understood that all of these percentages are provided on a weight basis. With this in mind, it should be apparent that the quantity of each additive can be varied without departure from the present invention.

Sugar and salt are added to improve the palatability of the meat. Potassium sorbate and araboascorbic acid serve as antiseptic agents. Araboascorbic acid also functions to brighten the color of the meat.

After the meat is mixed with the additives, the meat/additive mixture is ground or wrung into a paste. Any conventional grinder may be used for this grinding step. Such grinders are known to those having ordinary skill in the art and are available from commercial sources.

After rawhide is sterilized with ozone or by heating it at a temperature of from about 85 degrees Celsius to about 95 degrees Celsius for about 30 minutes, the sterilized rawhide is placed into a mold. The meat/additive mixture is then placed on the rawhide that is situated in the mold. When so placed, portions of the meat/additive mixture may overlap the edges of the rawhide. The mold is then compressed in a conventional manner to form a molded product which includes a combination of the meat/additive mixture and rawhide. As the mold compresses, the rawhide absorbs liquid from the meat/additive mixture such that the surface of the rawhide that is in contact with the meat/additive mixture (i.e., the top surface of the rawhide) is soaked with liquid.

The shape of the mold can be selected so as to approximate the desired configuration of the resulting pet treat 10. Any conventional molding machine may be used. Such molding machines are known to those having ordinary skill in the art and are available from commercial sources.

The molded product is then placed onto a conventional stainless steel shelf such that the meat/additive mixture is on top of the rawhide. Thereafter, the molded product is roasted in a conventional drying house for an extended period of time, such as more than 15 hours at a temperature of from about 65 degrees Celsius to about 85 degrees Celsius until its moisture content is reduced to less than about 14%. After the temperature in the drying house reaches more than approximately 60 degrees Celsius for more than 2 hours, the soaked, top surface of the rawhide is sufficiently converted to a layer of glutin. Because glutin is a viscous material, it binds the meat/additive mixture to the rawhide.

During the drying step, the rawhide is flavored by liquid seeped from the meat, thereby enhancing the palatability and scent of the rawhide, as well as reducing the hardness of the rawhide, which makes the rawhide more chewable and appealing. Likewise, the glutin that is formed during the drying step is flavored by liquid seeped from the meat, thereby enhancing the palatability of the glutin, which makes the glutin appealing. Because the molded product is roasted for more than 15 hours, the rawhide and the glutin are flavored with liquid seeped from the meat for a long period of time.

Lastly, the dried molded product is sterilized. More particularly, the dried molded product is irradiated at a minimum dose on the order of 7 kGy.

Referring to FIGS. 1-3, the pet treat 10 that results from the foregoing process contains a top layer 12 of meat and a bottom layer 14 of flavored rawhide, as well as an intermediate layer 16 of flavored glutin. The ratio of meat to rawhide can vary. In one embodiment, the ratio of meat to rawhide is approximately 30 to 70 by weight and/or by volume, but it is understood that the ratio can be higher or lower. The intermediate layer 16 of flavored glutin is thinner than the top layer 12 of meat and/or the bottom layer 14 of flavored rawhide.

It should be appreciated that the pet treat 10 provides numerous advantages over the prior art pet treats described above. Because the top layer 12 of the pet treat 10 includes meat, which is highly palatable, soft, and chewable, the pet treat 10 is initially attractive to pets. As the pet chews on the top layer 12 of meat and consumes the top layer 12 of meat, the pet will grind and scrape its teeth against the bottom layer 14 of flavored rawhide through the intermediate layer 16 of flavored glutin. Such grinding and scraping clean the teeth of the pet, thereby reducing plaque and tartar buildup, as well as providing jaw exercise for the pet.

The improved flavor, scent, and softness of the rawhide encourage the pet to chew on the bottom layer 14 of the pet treat 10 after the top layer 12 of meat is consumed. As a result, the pet will continue to grind and scrape its teeth against the bottom layer 14 of flavored rawhide.

As is evident from the description above, the pet treat 10 produced from the foregoing process is chewed for an extended period of time relative to pet treats that include only meat or rawhide. The highly palatable meat and the improved flavor of the rawhide cause the pet to maintain interest in the pet treat 10 until it is substantially or totally consumed. The pet treat 10 is suitable for indoor or outdoor consumption. The rawhide also functions as a support to maintain the shape of the pet treat 10.

It should be noted that the present invention can have numerous modifications and variations. For instance, the rawhide can be replaced by any animal skin, such as pork skin. The rawhide can be natural or reformed. The bottom layer 14 of the pet treat 10 can include other animal body parts, such as tracheas, tendons, pig ears, tails, hoofs, and bones, which could be knotted or compressed. The rawhide can be twisted, knotted, or rolled. Pure meat, without any additives, can be placed on the rawhide, thereby eliminating the need for a grinding step. All such variations and modifications are intended to be included within the scope of the invention as defined by the appended claims.

What is claimed is:

1. A method for making a pet treat, comprising the steps of:
adding meat to rawhide such that a bottom surface of meat is in contact with a top surface of the rawhide; and
roasting the meat/rawhide mixture so as to convert the top surface of the rawhide to a layer of glutin, thereby forming a top layer of meat, an intermediate layer of glutin, and a bottom layer of rawhide.

2. The method of claim 1, further comprising the step of mixing meat with additives so as to form a meat/additive mixture.

3. The method of claim 2, wherein the step of mixing meat with additives comprises mixing meat with sugar, salt, potassium sorbate, and araboascorbic acid.

4. The method of claim 3, wherein the step of mixing meat with additives comprises mixing meat with 1% to 1.2% of sugar, 0.6% to 1% of salt, 0.1% to 0.15% of potassium sorbate, and 0.04% to 0.1% of araboascorbic acid.

5. The method of claim 1, wherein the step of adding meat to rawhide comprises placing the rawhide into a mold and placing the meat on the rawhide situated in the mold.

6. The method of claim 5, wherein the meat/rawhide mixture is roasted for more than fifteen hours at a temperature of from about 65 degrees Celsius to about 85 degrees Celsius until the moisture content of the meat/rawhide mixture is reduced to less than about 14%.

7. The method of claim 1, wherein the ratio of meat to rawhide is approximately 30 to 70 by weight.

8. The method of claim 1, wherein the ratio of meat to rawhide is approximately 30 to 70 by volume.

9. The method of claim 1, further comprising the steps of washing the meat with a disinfecting agent and washing the meat with water.

10. The method of claim 9, further comprising the steps of sterilizing the meat/rawhide mixture and irradiating the meat/rawhide mixture.

11. A pet treat comprising:
a top layer of meat;
a bottom layer of rawhide; and
an intermediate layer of glutin situated between the top layer of meat and the bottom layer of rawhide.

12. The pet treat of claim 11, wherein the intermediate layer of glutin is made during a dehydration step performed for more than fifteen hours at a temperature of from about 65 degrees Celsius to about 85 degrees Celsius.

13. The pet treat of claim 11, wherein the top layer of meat includes sugar, salt, potassium sorbate, and araboascorbic acid.

14. The pet treat of claim 11, wherein the ratio of meat to rawhide is approximately 30 to 70 by weight.

15. The pet treat of claim 11, wherein the ratio of meat to rawhide is approximately 30 to 70 by volume.

16. The pet treat of claim 11, wherein the meat comprises chicken.

17. The pet treat of claim 11, wherein the rawhide includes a bottom surface, side surfaces, and an upper surface, and the meat is positioned on the upper surface of the rawhide, the side surfaces and the bottom surface of the rawhide being uncovered.
